(19) United States
(12) Patent Application Publication
(10) Pub. No.: US 2020/0179204 A1
(43) Pub. Date: Jun. 11, 2020

(54) SYSTEM FOR MOVING A USER

(71) Applicant: Michael Goldman, Denver, CO (US)

(72) Inventor: Michael Goldman, Denver, CO (US)

(21) Appl. No.: 16/211,580

(22) Filed: Dec. 6, 2018

(51) Int. Cl. A61G 7/10

(52) U.S. Cl. CPC A61G 7/1051; A61G 2203/12; A61G 7/1073; A61G 7/1046

(57) ABSTRACT

A system for moving a user from side to side is presented. The system has an elongated body that has an upper end and a lower end. The elongated body has an elongated arm that extends from the upper end of the elongated body. The system also has a base that is coupled to the lower end of the elongated body. A computer is attached to the elongated body of the system, but is removable. The system further has a sling that extends from the upper end of the elongated arm and the sling is placed around the body area of a user. The elongated arm may be retractable. Further, the system may be remotely controlled via wireless technologies. The system is securely configured for the base to fit under a bed while the sling is above the bed.

### FIELD OF THE INVENTION

This invention relates to moving systems. More particularly, it relates to moving systems with slings.

### BACKGROUND

A wide variety of products have been designed to move objects from one location to another and, in particular, transfer mobility-impaired individuals such as patients. In a hospital setting, patients must often be transported from their beds to an examination table or operating table, and back again. Basic devices for transferring patients include stretchers that are carried manually by two attendants, and wheeled gurneys that can more easily be handled by a single attendant.

There can still be problems, however, in getting a patient from a bed or other support surface onto a stretcher or gurney. If the patient is cooperative and not injured or disabled, it is a simple matter for the individual to slide over to the gurney with the assistance of a nurse, but if the patient is unconscious or has a disability or an injury (e.g., a broken bone) that might be worsened by movement, then great care must be taken in transferring the patient from the bed to the gurney. This problem is exacerbated when the patient is unusually heavy.

One solution to this problem is to slide a tray or sheet under the person and then, after the person is resting atop it, pull the tray or sheet off the bed and onto the gurney. A rigid tray can be forcibly inserted between the patient and the bed, and a sheet can be incrementally pushed under the person by first rocking him away from the gurney and then rocking back toward the gurney as the sheet is drawn under. This approach can still be difficult if the patient is uncooperative (i.e., unconscious), and can further be very uncomfortable even if the patient is cooperative, due to the frictional engagement of the tray with the body or the lack of firm support by the sheet.

Some transfer devices incorporate a rigid tray into the gurney that can move to the side and slide under a patient, and then slide back (while supporting the patient) to a centered position for transportation. In a further variation on this concept, the transfer device may use counter-rotating, endless belts to substantially eliminate friction against both the patient and the bed as support trays crawl under the patient. In one example, a first endless belt surrounds a set of upper trays and a second endless belt surrounds a set of lower trays, so the portions of the belts that are in contact (between the upper and lower tray sets) move in the same direction at the same rate as they counter-rotate. As the trays are inserted under the patient, the belt on the upper tray everts outwardly at the same rate as the translational movement of the trays to crawl under the patient without introducing any significant friction, and the belt on the lower tray similarly everts along the bed sheet. Once the patient is supported by the trays, the entire tray assembly is raised off the bed and the device can be rolled on casters to transport the patient.

There are still several serious problems with the counter-rotating belt designs. The entire transfer device (including the base and support members) moves as the trays are inserted under the patient, and the base must extend under the bed or table in order to prevent the device from tipping over when the patient is carried. Because of this limitation, such devices cannot be used in all settings, i.e., wherein there is insufficient clearance space under the bed or table (a situation becoming more common as more accouterments are added to beds and tables that occupy the space underneath). These devices further only allow loading and unloading along one side of the device, which can present problems when the patient is not suitably oriented (head-to-feet) on the device with respect to the bed or table. These Design are also not particularly comfortable as there is only a thin layer of the belt interposed between the patient and the hard surface of the metal support trays. Moreover, hospitals are becoming increasingly concerned with potential contamination from patient fluids, and the prior art belt-type transfer devices are difficult if not impossible to properly clean.

In light of the foregoing, it would be desirable to devise an improved patient transfer device that provided more flexibility in deployment while still being easy to operate and maneuver. It would be further advantageous if the device were more comfortable for the patient, yet could still maintain the patient in a stabilized manner during transport.

### BRIEF DESCRIPTION OF THE DRAWINGS

FIG. 1 is an illustrated a system for moving a user from side to side.

FIG. 2 is an illustrated use of the system shown in FIG. 1.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

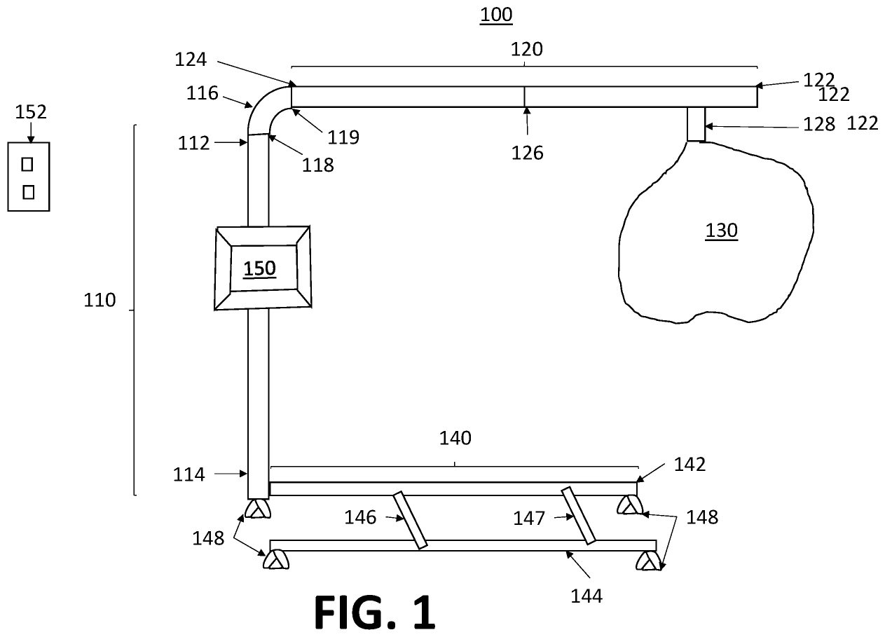

Referring to FIG. 1, a system 100 for moving a user from side to side is presented. The system 100 is useful for providing transfer of a user from one location to another location. Also, the system 100 is useful for lifting a user and moving the user to a side or from side to side to allow the changing of sheets or other bedding material.

The system 100 has an elongated body 110. The elongated body 110 may be made of any material such as preferably surgical plastic, aluminum, etc. The elongated body 110 may be adjustable to different lengths and/or heights, or may be non-adjustable. The elongated body 110 has an upper end 112 and a lower end 114.

The upper end 112 of the elongated body 110 may be coupled to a coupling elbow 116. The coupling elbow 116 is useful for coupling other elements of the system 100. This will be described in more detail later. The coupling elbow 116 is show as an elbow but may be a ball or other type of apparatus which allows for the coupling elbow 116 to be movable in multiple directions.

The coupling elbow 116 has a first end 118 and a second end 119. The upper end 112 of the elongated body 110 is coupled to the first end 118 of the coupling elbow 116.

The system 100 also has an elongated arm 120. The elongated arm 120 is useful for extending the system 110 horizontally to reach further from the elongated body 110.

The elongated arm 120 may be made of any material such as preferably surgical plastic, aluminum, etc. The elongated arm 120 is preferably adjustable to different lengths or may be non-adjustable. The elongated rm 120 has an upper portion 122 and a lower portion 124.

The lower portion 124 of the elongated arm 120 may be coupled to the upper end 116 of the elongated body 110 or may be coupled to the second end 119 of the coupling elbow 116.

The elongated arm 120 further be made of more than one section, such that the one or more sections may be coupled at, for example, connector 126. The connector 126 is useful for allowing the elongated arm 120 to be extended or retracted to a desired length.

The elongated arm 120 may also have an extendable coupling 128. The extended coupling 128 is useful for providing a spacing between a coupled element to the elongated arm 120.

The system 100 has a sling 130. The sling 130 is useful for securely carrying or coupling around a user to lift, transfer or move the user from side to side, up and down, etc. The sling is made of a soft, pliable but strong material, such as plastic, cloth, etc.

To stabilize and prove a secure system 100, the system 100 has a base 140. The base 140 is useful for stabilizing the system 100 and for allowing the system 100 to be moved securely as well as balance the system 100. The base 140 is coupled to the lower end 114 of the elongated body 110.

The base 140 has a plurality of legs 142, 144. The legs 142, 144 may be made of any material such as aluminum, etc. The legs 142, 144 are preferably rectangular in shape but may be any shape that can provide a secure, balanced base 140.

The legs 142, 144 are coupled together to provide additional strength and/or stability. The braces 146, 147 are coupled to the legs 142, 146 preferably equal distance apart. The base 140 and the legs 142, 144 further have feet 148. The feet 148 may be wheels, caster wheels, ball, etc. The feet 148 allow for the system 100 to be easily transportable to a desire location. The feet 148 preferably have a locking mechanism to prevent the system from moving when it is desired to have the system 100 stationary.

The system 100 further has a computer 150. The computer is useful in controlling the system 100 and the movement of the elongated arm 120 and the sling 130.

The computer 150 may be in direct communication with the system 100, and may allow access directly by an operator of the system 100. The computer 150 may be touch-screen, buttons, toggle switches, etc.

The computer 150 may have communication using wireless technologies. The computer 150 may have a external or remote control 152 controller. The control 152 may be located in the same room as the system or may be remote to the room. The control 152 may send and receive control signals or commands with the computer 150 utilizing the wireless technologies.

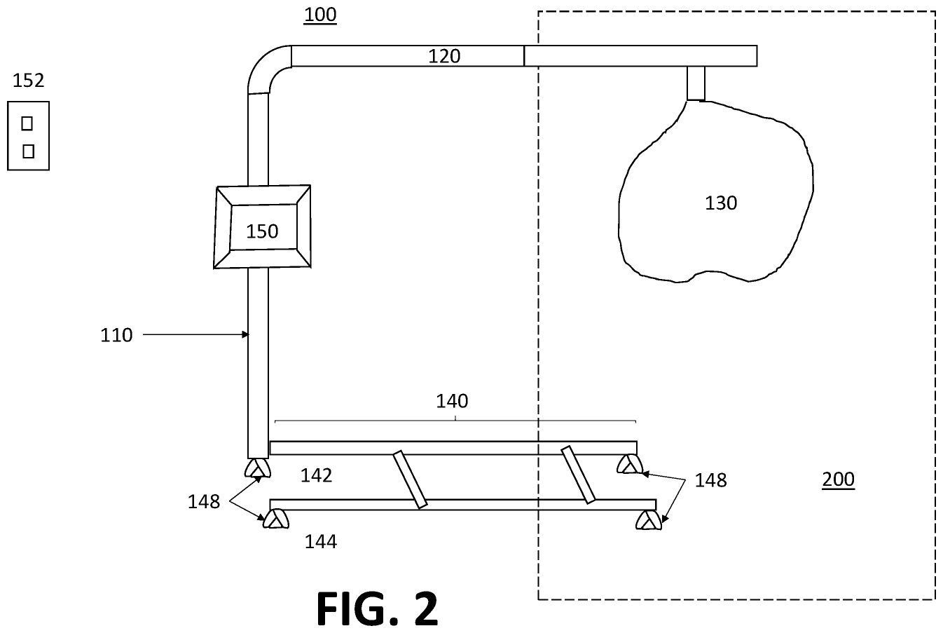

Moving now to FIG. 2, an exemplary usage of the system 100 described in FIG. 1 is presented.

The system 100 has the elongated body 110 coupled to the elongated arm 120 using the coupling elbow 116. The elongated arm 120 is coupled on the upper end 122 to the sling 130.

The elongated body 110 of the system 100 is coupled to the base 140. The base 140 has legs 142, 144 and feet 148.

The system 100 further has a computer 150 and a remote control 152 for controlling the movement and usage of the system 100.

It is determined that a user needs to moved. An operator, either via the computer or manually, positions the system 100 at the side of a bed 200. The legs 142, 144 of the base 140 are positioned under the bed 200 and the sling 130 coupled to the elongated arm 120 is positioned above the bed 200.

The sling 130 is lowered and the user is placed into the sling 130. The elongated arm 120 is maneuvered such that the user in the sling 130 is lifted from the bed 200. The user can either be moved from side to side, moved up or down, etc.

The system 100 is moved away from the bed 200 and the user is placed into a desired location. At this time, the user may have been transferred to a chair, to a gurney, to a wheel chair, etc. The bed 200 may be changed at this time or other activities may be taken.

The user being in the sling 130 is then desired to be moved back into the bed 200. The system 100 is then moved back to the bed 200 and the feet 142, 144 of the base 140 are moved under the bed 200 and the user in the sling 130 are positioned appropriately above the bed 200.

The sling 130 coupled to the elongated arm 120 is moved to gently place the user back into the bed 200. The sling 130 is then removed from around the user. The system 100 is then maneuvered away from the bed 200 using the computer 150 and the remote control 152. The system 100 is moved to a storage position ready to be used for the next user.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A system for moving a user from side to side, comprising:
an elongate body having an upper end and a lower end;
an elongate arm, said elongate arm extending from said upper end of said elongate body;
a base, said base coupled to said lower end of said elongate body;
a computer, said computer removably coupled to said elongate body; and
a sling, said sling extending from an upper portion of said elongate arm; and
wherein said sling is configured to be placed around a body area of said user.

2. The system of claim 1, further comprising a remote control.

3. The system of claim 1, wherein said elongate arm is retractable.

4. The system of claim 1, wherein said elongate arm is parallel to said base in a first configuration of said system.

5. The system of claim 1, wherein said elongate arm is perpendicular to said elongate body in a first configuration of said system.

6. The system of claim 1, wherein said elongate arm makes a 90-degree angle with said elongate body in a first configuration of said system.

7. The system of claim 1, wherein said computer is located in a central portion of said elongate body.

8. The system of claim 1, wherein said system is configured to fit under a bed.

9. A system for moving a user from side to side, comprising:
an elongate body having an upper end and a lower end;
an elongate arm, said elongate arm extending from said upper end of said elongate body;
a base, said base coupled to said lower end of said elongate body;
a computer, said computer removably coupled to said elongate body; and
a sling, said sling extending from an upper portion of said elongate arm and wherein said sling is configured to be placed around a body area of said user;
a remote control; and
wherein said elongate arm is retractable;
wherein said elongate arm is parallel to said base in a first configuration of said system;
wherein said elongate arm is perpendicular to said elongate body in a first configuration of said system;
wherein said elongate arm makes a 90-degree angle with said elongate body in a first configuration of said system;
wherein said computer is located in a central portion of said elongate body; and
wherein said system is configured to fit under a bed.
